(19) United States
(12) Patent Application Publication
(10) Pub. No.: US 2013/0061483 A1
(43) Pub. Date: Mar. 14, 2013

(54) Tile template

(71) Applicant: John Wynn, Lavista, NE (US)

(72) Inventor: John Wynn, Lavista, NE (US)

(21) Appl. No.: 13/199,769

(22) Filed: Sep. 8, 2011

(51) Int. Cl. B43L 7/00

(52) U.S. Cl. 33/566

(57) ABSTRACT

A tile template is provided which is comprised of a square-shaped flexible member which is preferably constructed of a non-skid rubber material. The flexible member has a plurality of alternating openings and a plurality of alternating squares provided therein. The underside of the tile template is provided with numbered fold lines. In one embodiment, the fold lines include a plurality of horizontally extending fold lines and a plurality of vertically extending fold lines. In another embodiment, the fold lines extend diagonally across the template.

### BACKGROUND OF THE INVENTION

1. Field of the Invention

This invention relates to a tile template and more particularly to a square-shaped tile template which is comprised of a non-slip flexible material or fabric having alternating rectangular holes and square solid portions. Even more particularly, the bottom side of the template has a fold line numbering system thereon to enable the template to be folded to a particular configuration to fit the space into which a tile is to be placed, with the fold lines being noted or marked so that the template may be placed on a tile and folded to that configuration for marking the tile. The openings in the template enable an outlet, pipe opening or the like to be visible therethrough with the cut-out being traced on the template so that the template may be placed on a tile so that the tile may have the outlet configuration marked thereon by sticking a pencil or the like through the marked openings in the template.

2. Description of the Related Art

Many types of tile templates have been previously provided to enable a tile to be marked and cut to a configuration wherein the tile may be properly placed on a horizontal surface or a vertical surface. For example, see U.S. Pat. Nos. 4,212,110; 4,659,409; 5,673,490; 5,922,157 and 6,834,438. See also Published Applications Nos. 2003/0061722 and 2006/0005910.

None of the tile templates of the prior art are comprised of a flexible non-slip material with alternating openings and solid squares formed therein which enables the template to be placed on the area wherein the tile is to be placed, folded to match the shape of the opening in which the tile will be placed, and then transfer that folded member to the tile to be cut.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A tile template is disclosed which comprises a square-shaped flexible member having an upper side and a lower side as well as top edge, a lower edge, a right edge, and a left edge. The flexible member has a plurality of alternating rectangular holes and square-shaped solid portions. The lower side of the flexible member has a fold line numbering system provided thereon. In the preferred embodiment, the flexible member is comprised of a non-slip material.

It is therefore a principal object of the invention to provide an improved tile template.

A further object of the invention is to provide a square-shaped flexible member comprised of a non-slip material and which has a plurality of alternating rectangular openings and square solid portions formed therein.

A further object of the invention is to provide a template of the type described which is extremely versatile and which may be folded to practically any shape to conform to the area in which the tile is to be placed.

A further object of the invention is to provide a tile template having a plurality of alternating openings formed therein which enables a person to view outlets, pipe openings, etc. and to trace those openings on the flexible member.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a top plan view of the small tile template of this invention;

FIG. 2 is a top plan view of the large tile template of this invention;

FIG. 3 is a bottom plan view of the tile template of this invention;

FIG. 4 is a partial bottom plan view of one embodiment of the tile template of this invention wherein the fold line numbering system on the lower side of the template is diamond-shaped;

FIG. 5 is a perspective view of the tile template of this invention with one corner thereof folded over onto the top surface of the template to correspond to the tile to be cut;

FIG. 6 is a top plan view of the tile template of this invention placed on a corner area into which a tile is to be placed with two of the corners of the template being folded onto the top surface of the template to correspond to the shape of the tile to be placed in the area;

FIG. 7 is an exploded perspective view illustrating the manner in which the folded template of FIG. 6 may be placed on a tile so that the tile may be marked and cut to correspond to the area onto which the cut tile is to be placed;

FIG. 8 is a perspective view of an electrical wall outlet over which a tile is to be placed; and

FIG. 9 is an exploded perspective view illustrating how the marked template may be positioned on the tile to be placed over the outlet of FIG. 8 and marked so that the tile will have a cut-out area marking the outlet of FIG. 8.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

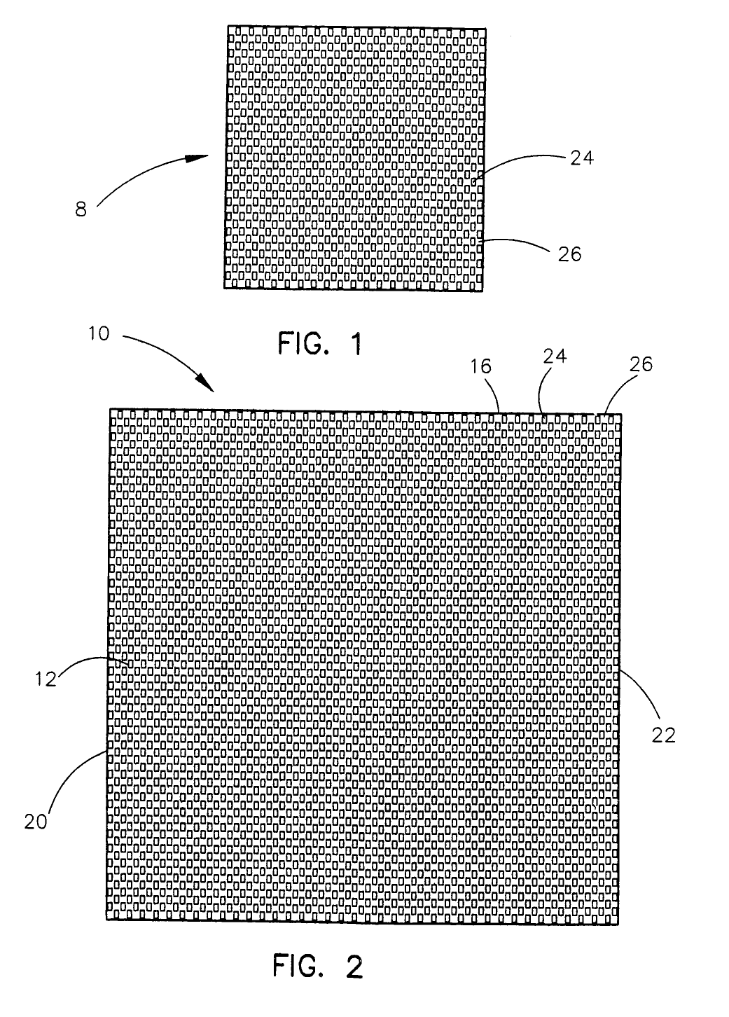

In FIG. 1, the numeral 8 refers to the small sized tile template of this invention. In FIG. 2, the numeral 10 refers to the larger sized tile template of this invention. Templates 8 and 10 are identical except for the sizes thereof. The size of the template will depend upon the size of the tiles being installed or laid. Since templates 8 and 10 are identical except for the sizes thereof, only template 10 will be described in detail.

Template 10 is comprised of a non-skid flexible material such as rubber or plastic but is preferably comprised of a rubber material. Template 10 will be described as having an upper surface 12, a lower surface 14, a top edge 16, a bottom edge 18, a left edge 20 and a right edge 22. Template 10 has a plurality of alternating openings 24 and a plurality of alternating solid portions 26 formed therein. The openings 24 may be square-shaped or rectangular-shaped. The openings 24 may have other shapes as well. The solid portions 26 may be square-shaped or rectangular-shaped. The square portions 26 may have other shapes also.

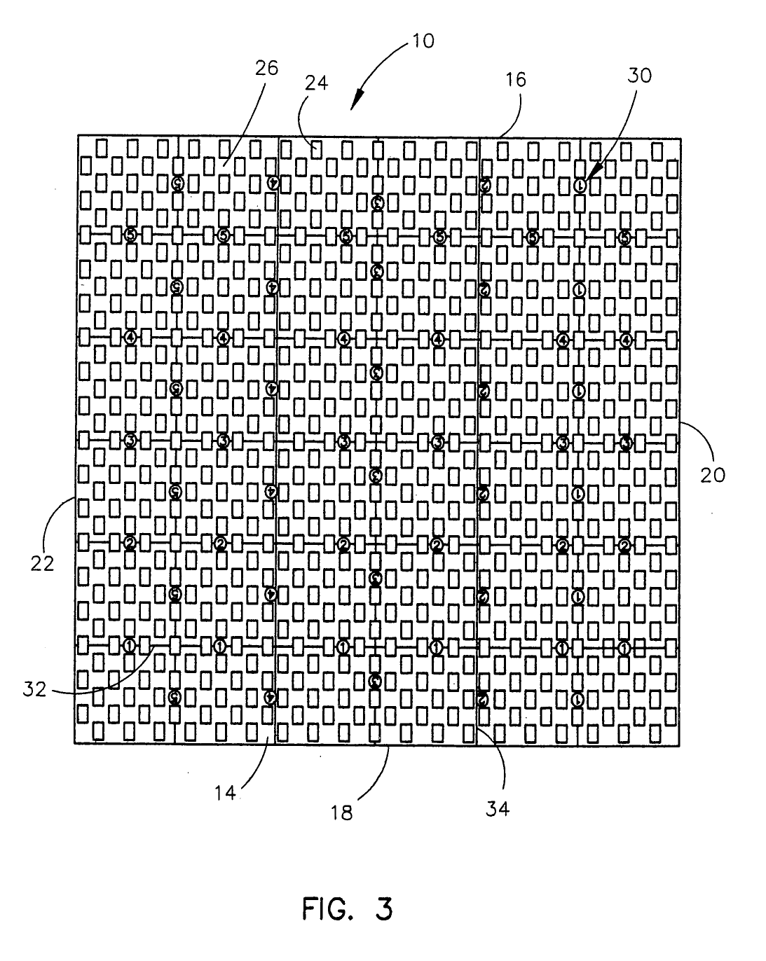

The back side or lower surface 14 has a fold line numbering system provided thereon which is referred to generally by the reference numeral 30. Fold line numbering system 30 includes a plurality of horizontally extending and spaced-apart numbered fold lines from 1 to 5 as seen in FIG. 3 and which are generally referred to by the reference numeral 32. Fold line numbering system 30 also includes a plurality of vertically extending and spaced-apart numbered fold lines 1 to 5 as seen in FIG. 3 and which are generally referred to by the reference numeral 34.

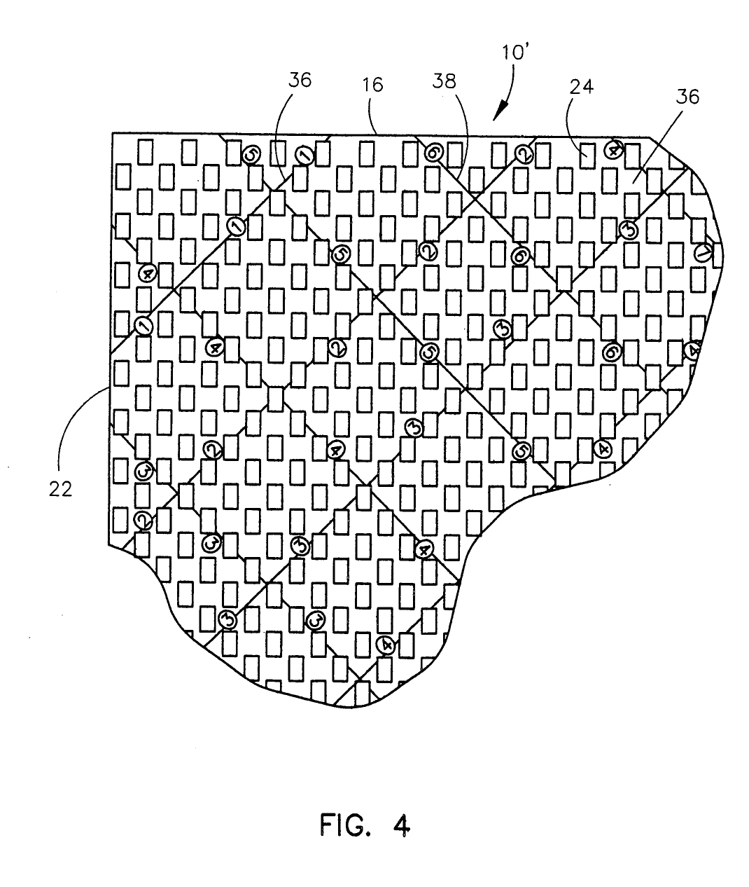

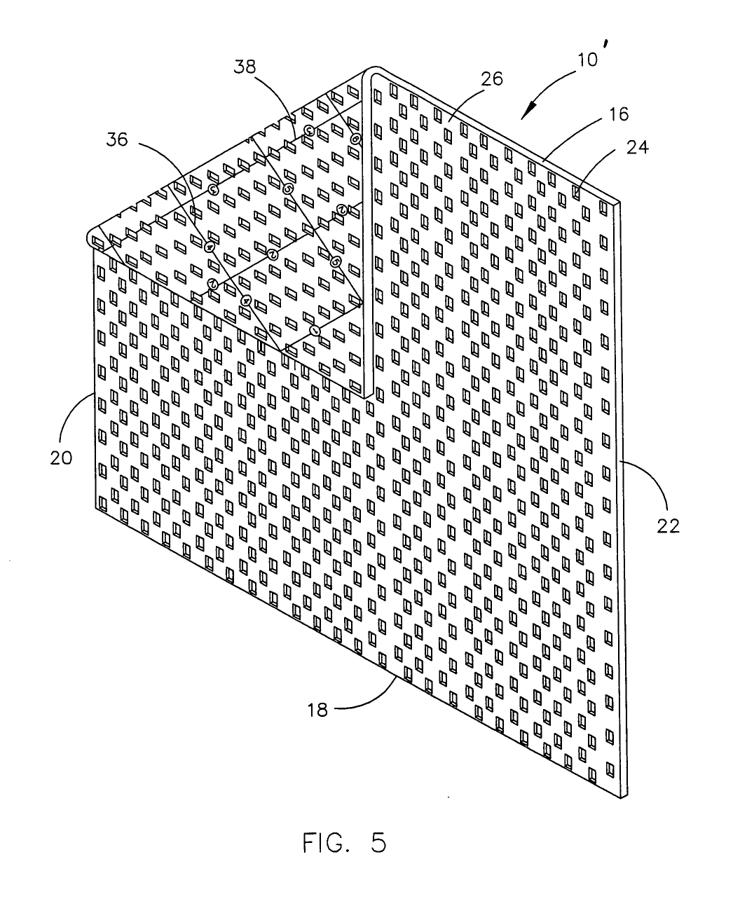

In the embodiment 10′ of FIGS. 4 and 5, the fold line numbering system comprises diagonally extending fold lines rather than the horizontally and vertically extending fold lines as seen in FIG. 3. In the embodiment of FIGS. 4 and 5, a first set of diagonally extending fold lines are designated by the reference numeral 36. The numeral 38 refers to a second set of diagonally extending fold lines which intersect the fold lines 34 at a right angle.

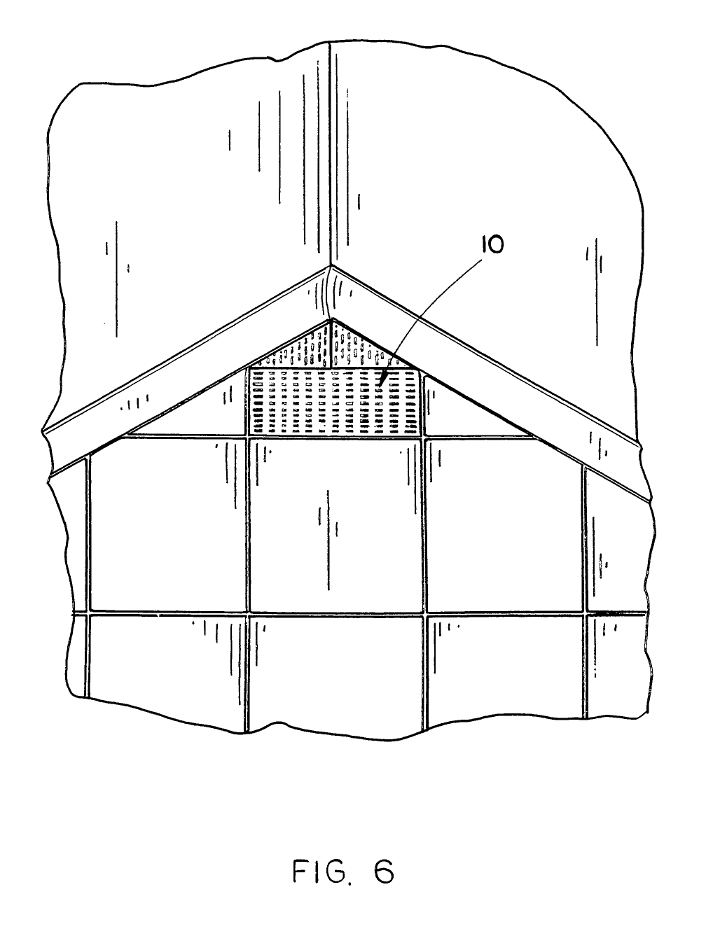

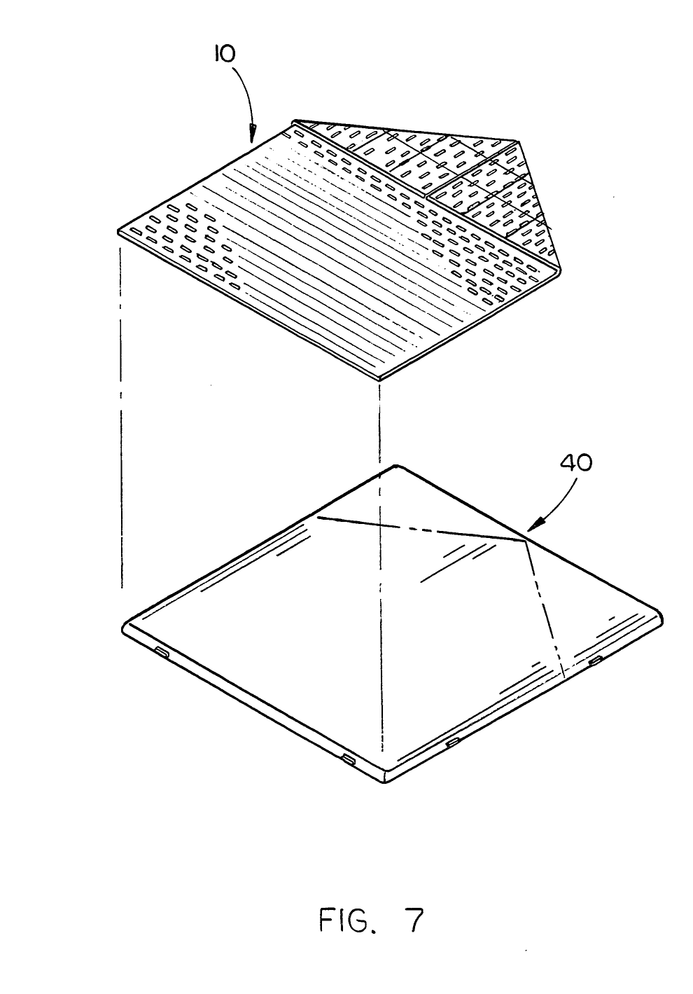

The template 10 by being comprised of a flexible non-skid material is able to be folded upon itself such as illustrated in FIG. 5 so that the template may be folded to correspond to the space in which a tile is to be placed. For example, in FIG. 6, the tile is to be placed in a corner of a wall of a building. The template 10 is placed in the space where the tile is to be placed with the corners thereof being folded upon themselves so that the template 10 corresponds to the shape of the tile which is to be placed in the space. When the corners are folded back, the numbered fold lines will be visible to the tile installer and the fold lines may be noted and recorded or lines may be drawn on the folded corners. The folded template 10, as seen in FIG. 7, is then placed on a tile 40, the tile 40 being marked and the tile 40 is then cut along the marked lines as seen in FIG. 7 so that the tile 40 will fit into the space at the corner of the wall system of FIG. 6. The tiles 40 will have grout between the edges thereof, that is taken into consideration in folding the template 10 and marking the same on the tile 40.

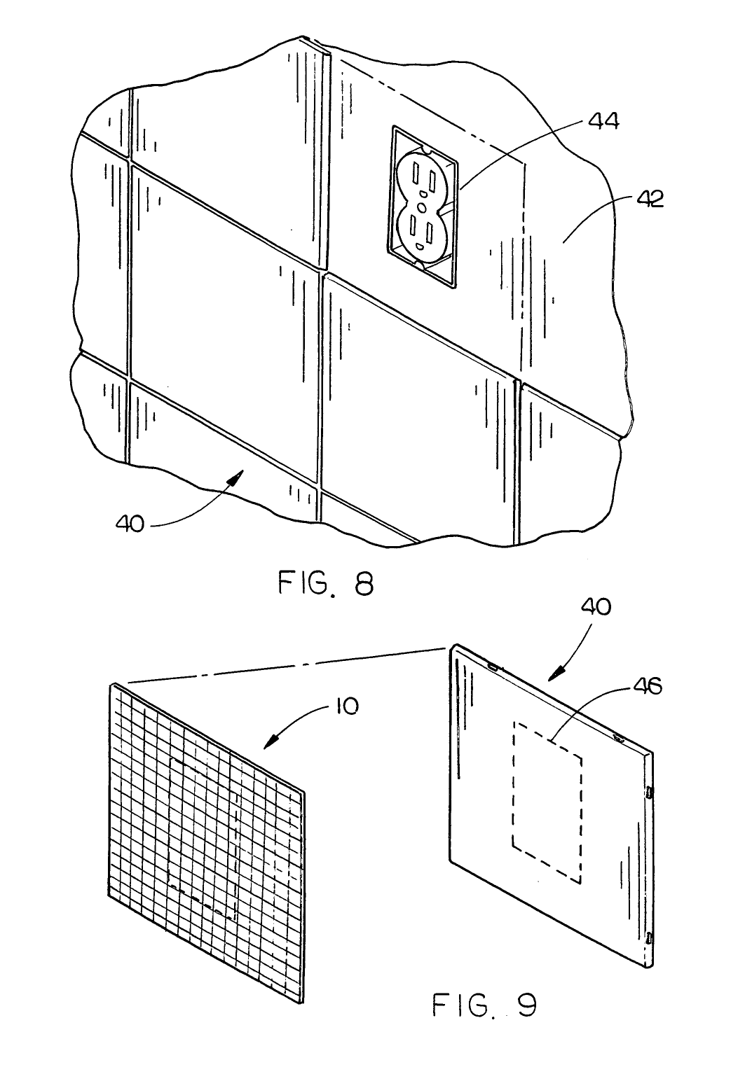

The template of this invention has many uses. It may be used to mark cut-outs for such things as an outlet 44 or a pipe opening formed in wall 42. As seen in FIG. 8, the space in which tile is to be placed has an outlet 44 formed therein. The template 10 is then placed over the outlet 44 in the position that the tile 40 will be placed. The outline of the outlet 44 will be visible through the openings in the template 10 and the outline of the outlet 44 may be traced onto the template 10 as illustrated in FIG. 9. The marked template 10 is then placed over the tile 40 and the outline of the outlet 44 may be traced onto the tile 40 as seen by the reference numeral 44 in FIG. 9. The markings 46 may be placed on the tile 40 by sticking pencil or pen through the openings in the template.

Thus it can be seen that a novel tile template has been provided which makes the installation of tiles more rapid and much more accurate. It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A tile template, comprising:
a square-shaped flexible member having an upper side, a lower side, a top edge, a bottom edge, a right edge and a left edge;
said flexible member having rows of alternating openings and solid portions formed therein.

2. The tile template of claim 1 wherein said lower side of said flexible member has fold line numbering indicia provided thereon.

3. The tile template of claim 2 wherein said fold line numbering indicia comprises a plurality of spaced-apart numbered horizontal fold lines which extend between said left and right edges of said flexible member and a plurality of spaced-apart numbered vertical fold lines which extend between said top and bottom edges of said flexible member.

4. The tile template of claim 2 wherein said fold line numbering indicia comprises a plurality of spaced-apart first numbered fold lines which extend diagonally across said flexible member and a plurality of spaced-apart second numbered fold lines which extend diagonally across said flexible member which intersect said first numbered fold lines at a right angle.

5. The tile template of claim 1 wherein said openings are rectangular-shaped.

6. The tile template of claim 1 wherein said solid portions are square-shaped.

7. The tile template of claim 2 wherein said openings are rectangular-shaped.

8. The tile template of claim 2 wherein said solid portions are square-shaped.

9. The tile template of claim 1 wherein said flexible member is comprised of a rubber material.

10. The tile template of claim 1 wherein said flexible member is comprised of a non-slip material.
